(19) United States
(12) Patent Application Publication
(10) Pub. No.: US 2026/0051490 A1
(43) Pub. Date: Feb. 19, 2026

(54) Positive Electrode Active Material, and Positive Electrode and Lithium Secondary Battery Which Include the Same

(71) Applicant: LG Chem, Ltd., Seoul (KR)

(72) Inventors: Ye Hyeon Gu, Daejeon (KR); Jin Hoo Jeong, Daejeon (KR); Jong Hyun Shim, Daejeon (KR); JooK young Hwang, Daejeon (KR); Ji Young Lee, Daejeon (KR); Hyeon Mo Ryu, Daejeon (KR)

(73) Assignee: LG Chem, Ltd., Seoul (KR)

(21) Appl. No.: 19/104,428

(22) PCT Filed: Sep. 5, 2023
(86) PCT No.: PCT/KR2023/013250

§ 371 Date: Feb. 18, 2025

(30) Foreign Application Priority Data
Sep. 8, 2022 (KR) 10-2022-0113918

(51) Int. Cl. H01M 4/525; H01M 4/02; H01M 10/0525; H01M 50/40

(52) U.S. Cl. CPC H01M 4/525; H01M 10/0525; H01M 50/40; H01M 2004/028

(57) ABSTRACT

A positive electrode active material includes a lithium transition metal composite oxide in a form of a single particle containing nickel, cobalt, and manganese, wherein the lithium transition metal composite oxide contains 60 mol % or more of the nickel among total transition metals and has a D₅₀ of 5 μm or more. A positive electrode and a lithium secondary battery including the positive electrode active material are also provided.

### CROSS-REFERENCE TO RELATED APPLICATIONS

The present application is a national phase entry under 35 U.S.C. § 371 of International Application No. PCT/KR2023/013250 filed Sep. 5, 2023, which claims priority from Korean Patent Application No. 10-2022-0113918, filed on Sep. 8, 2022, the disclosures of which are incorporated by reference herein.

### TECHNICAL FIELD

The present disclosure relates to a positive electrode active material, and a positive electrode and a lithium secondary battery which include the same.

### BACKGROUND ART

With the recent technological development of electric vehicles, demand for high-capacity secondary batteries is increasing, and, accordingly, research on a high nickel (high Ni) positive electrode active material having excellent capacity characteristics is being actively conducted.

With respect to the high nickel positive electrode active material formed in a secondary particle structure in which primary particles are aggregated, structural degradation occurs during charge and discharge of a lithium secondary battery, but a relatively large change in lattice structure constant, that is, a relatively large volume change in unit lattice occurs. This volume change causes cracks in the positive electrode active material. Also, cracks may occur in the positive electrode active material due to pressure even during electrode rolling.

The cracks thus occurred in the high nickel positive electrode active material become more severe in a charging and discharging process of the lithium secondary battery, and accordingly, since the crack acts as a void that may not be reached by an electrolyte solution or reduces conductivity, it degrades life characteristics of the lithium secondary battery or acts as a factor in increasing resistance.

As a way to minimize the occurrence of the cracks in the secondary particle structure, attempts are being made to prepare a positive electrode active material in a form of a single particle. Conventionally, in order to prepare the positive electrode active material in the form of a single particle, after a transition metal hydroxide prepared by a co-precipitation method is mixed with a lithium compound and expanded secondary particles are first prepared by over-sintering the mixture, the secondary particles are ground to be prepared as a form of a single particle. However, in a case in which the positive electrode active material in the form of a single particle is prepared as described above, since diameters of primary particles constituting the secondary particle are non-uniform, there is a problem in that a particle size distribution of the positive electrode active material in the form of a single particle, which is obtained after the grinding, is increased. But, since performance and electrode design of the lithium secondary battery vary greatly depending on the particle size distribution of the positive electrode active material, it is very important to control the particle size distribution and average particle diameter of the positive electrode active material.

### Prior Art Documents

### Patent Documents

(Patent Document 1) KR 10-1785262 B1
(Patent Document 2) KR 10-2017-0119573 A

### Technical Problem

An aspect of the present disclosure provides a positive electrode active material in a form of a single particle, in which an average particle diameter is controlled, while having a negative skewness.

Another aspect of the present disclosure provides a positive electrode and a lithium secondary battery in which rolling density during preparation of the positive electrode is improved by including the positive electrode active material in the form of a single particle.

### Technical Solution

In order to solve the above-described tasks, the present disclosure provides a method of preparing a positive electrode active material, the positive electrode active material prepared therefrom, and a positive electrode and a lithium secondary battery which include the same.

(1) The present disclosure provides a positive electrode active material including a lithium transition metal composite oxide in a form of a single particle which contains nickel, cobalt, and manganese, wherein the lithium transition metal composite oxide contains 60 mol % or more of the nickel among total transition metals, has a D₅₀ of 5 μm or more, and has a rolling density calculated by Equation 3 of 3.56 g/cm³ or more when a pellet is formed by applying a force until the force reaches 9,000 kgf using an automatic pellet press.

$$Rolling density ( g / {cm}^{3} ) = positive electrode active material weight ( g ) / pellet volume ( {cm}^{3} ) \qquad [ Equation 3 ]$$

(2) The present disclosure provides the positive electrode active material of (1) above, wherein the lithium transition metal composite oxide in the form of a single particle is a single particle or a secondary particle in which 10 or less primary particles are aggregated.

(3) The present disclosure provides the positive electrode active material of (1) or (2) above, wherein the lithium transition metal composite oxide has an average composition represented by Formula 1.

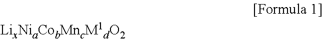

In Formula 1, M¹ is at least one selected from the group consisting of aluminum (Al), zirconium (Zr), boron (B), tungsten (W), molybdenum (Mo), chromium (Cr), niobium (Nb), magnesium (Mg), hafnium (Hf), tantalum (Ta), lanthanum (La), titanium (Ti), strontium (Sr), barium (Ba), cerium (Ce), fluorine (F), phosphorus (P), sulfur(S), and yttrium (Y), and 0.95≤x≤1.3, 0.65≤a<1.0, 0<b<0.4, 0<c<0.4, 0≤d≤0.2, and a+b+c+d=1.

(4) present disclosure provides the positive electrode active material of (3) above, wherein x is in a range of from 0.9 to 1.1.

(5) The present disclosure provides the positive electrode active material of any one of (1) to (4) above, wherein the D₅₀ is in a range of from 5 μm to 9 μm.

(6) The present disclosure provides the positive electrode active material of any one of (1) to (5) above, wherein the rolling density is in a range of from 3.56 g/cm³ to 3.80 g/cm³.

(7) The present disclosure provides the positive electrode active material of any one of (1) to (6) above, wherein a mode in a cumulative distribution of volume according to a particle diameter is greater than the D₅₀.

(8) The present disclosure provides the positive electrode active material of (7) above, wherein the positive electrode active material has a negative skewness value calculated by Equation 1 of greater than 0.

$$Negative skewness = ( Mode - {D}_{10} ) / {D}_{50} \qquad [ Equation 1 ]$$

(9) The present disclosure provides the positive electrode active material of (8) above, wherein the negative skewness value is in a range of from 0.40 to 0.75.

(10) The present disclosure provides a positive electrode including the positive electrode active material of any one of (1) to (9).

(11) The present disclosure provides a lithium secondary battery including the positive electrode of (10); a negative electrode; a separator disposed between the positive electrode and the negative electrode, and an electrolyte.

### Advantageous Effects

Since a positive electrode active material of the present disclosure is in a form of a single particle, in which an average particle diameter is controlled, while having a negative skewness, energy density of a lithium secondary battery may be increased by improving rolling density when a positive electrode is prepared by including the positive electrode active material, and, accordingly, capacity characteristics are improved.

### BRIEF DESCRIPTION OF THE DRAWINGS

FIG. 1 is a graph illustrating a cumulative volume distribution according to a particle diameter of each of positive electrode active materials prepared in Examples and Comparative Examples of the present disclosure.

FIG. 2 is a scanning electron microscope image of a positive electrode active material prepared in Example 1 of the present disclosure.

FIG. 3 is a scanning electron microscope image of a positive electrode active material prepared in Example 2 of the present disclosure.

FIG. 4 is a scanning electron microscope image of a positive electrode active material prepared in Example 3 of the present disclosure.

FIG. 5 is a scanning electron microscope image of a positive electrode active material prepared in Example 4 of the present disclosure.

FIG. 6 is a scanning electron microscope image of a positive electrode active material prepared in Example 5 of the present disclosure.

FIG. 7 is a scanning electron microscope image of a positive electrode active material prepared in Example 6 of the present disclosure.

FIG. 8 is a scanning electron microscope image of a positive electrode active material prepared in Example 7 of the present disclosure.

FIG. 9 is a scanning electron microscope image of a positive electrode active material prepared in Comparative Example 1 of the present disclosure.

FIG. 10 is a scanning electron microscope image of a positive electrode active material prepared in Comparative Example 2 of the present disclosure.

FIG. 11 is a scanning electron microscope image of a positive electrode active material prepared in Comparative Example 3 of the present disclosure.

FIG. 12 is a scanning electron microscope image of a positive electrode active material prepared in Comparative Example 4 of the present disclosure.

### DETAILED DESCRIPTION

Hereinafter, the present disclosure will be described in more detail to allow for a clearer understanding of the present disclosure.

It will be understood that words or terms used in the specification and claims shall not be interpreted as the meaning defined in commonly used dictionaries, and it will be further understood that the words or terms should be interpreted as having a meaning that is consistent with their meaning in the context of the relevant art and the technical idea of the disclosure, based on the principle that an inventor may properly define the meaning of the words or terms to best explain the disclosure.

In the present disclosure, the expression ‘primary particle’ denotes a smallest particle unit which is distinguished as one body when a cross section of a positive electrode active material is observed through a scanning electron microscope (SEM), wherein it may be composed of a plurality of crystallites.

In the present disclosure, the expression ‘secondary particle’ denotes a secondary structure formed by aggregation of a plurality of primary particles. An average particle diameter of the secondary particle may be measured using a particle size analyzer.

The terms ‘D₁₀’, ‘D₅₀’, and ‘D₉₀’ in the present disclosure denote particle diameters at 10% (D₁₀), 50% (D₅₀), and 90% (D₉₀) of cumulative distribution of volume according to the particle diameter, respectively. After dispersing measurement target powder in a dispersion medium, the dispersion medium is introduced into a commercial laser diffraction particle size measurement instrument (e.g., mastersizer 3000 by Malvern Panalytical Ltd.), a cumulative distribution of volume according to a particle diameter is calculated by measuring a difference in diffraction patterns due to a particle size when particles pass through a laser beam, and the D₁₀, D₅₀, and D₉₀ may be measured by calculating particle diameters at 10%, 50%, and 90% of the cumulative distribution of volume according to the particle diameter using the measurement instrument. Also, the D₅₀ in the present disclosure may be expressed as an average particle diameter.

The expression ‘form of a single particle’ in the present disclosure has a meaning including that a particle of a positive electrode active material and/or a lithium transition metal composite oxide is both a single particle and a form in which 2 to 10 particles are aggregated. That is, in the positive electrode active material in a form of a single particle and/or lithium transition metal composite oxide in a form of a single particle of the present disclosure, a particle of the positive electrode active material and/or lithium transition metal composite oxide may include at least one selected from the group consisting of a single particle and a particle in which 2 to 10 particles are aggregated.

### Positive Electrode Active Material

The present disclosure provides a positive electrode active material.

According to an embodiment of the present disclosure, the positive electrode active material includes a lithium transition metal composite oxide in a form of a single particle which contains nickel, cobalt, and manganese, wherein the lithium transition metal composite oxide contains 60 mol % or more of the nickel among total transition metals, has a D₅₀ of 5 μm or more, and may have a rolling density calculated by the following Equation 3 of 3.56 g/cm³ or more when a pellet is formed by applying a force until the force reaches 9,000 kgf using an automatic pellet press.

$$Rolling density ( g / {cm}^{3} ) = positive electrode active material weight ( g ) / pellet volume ( {cm}^{3} ) \qquad [ Equation 3 ]$$

According to an embodiment of the present disclosure, the positive electrode active material may include a lithium transition metal composite oxide in a form of a single particle. As a specific example, the lithium transition metal composite oxide in the form of a single particle may be a single particle or a secondary particle in which 10 or less primary particles are aggregated. With respect to a conventional positive electrode active material in a form of a secondary particle in which more than 10 primary particles were aggregated, porosity had to be increased in order to minimize cracks which were caused by pressure during rolling for preparation of an electrode, and this eventually causes a decrease in energy density of a lithium secondary battery. However, in a case in which the lithium transition metal composite oxide has the form of a single particle or a secondary particle in which 10 or less primary particles are aggregated as in the positive electrode active material of the present disclosure, when charging and discharging a lithium secondary battery, cracks due to a volume change in a unit lattice may be minimized, particularly, cracks caused by the pressure during rolling for the preparation of the electrode may be minimized. Thus, in a case in which the positive electrode active material of the present disclosure is used, since rolling may be performed to have lower porosity during the rolling for the preparation of the electrode, energy density of the lithium secondary battery may be improved.

According to an embodiment of the present disclosure, the lithium transition metal composite oxide may be a high nickel-based lithium transition metal composite oxide which contains nickel and has a nickel (Ni) content of 60 mol % or more based on total transition metals. In this case, high energy density may be ensured due to the high nickel content.

According to an embodiment of the present disclosure, the lithium transition metal composite oxide may have an average composition represented by Formula 1 below.

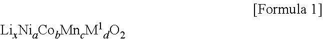

In Formula 1, M¹ is at least one selected from the group consisting of aluminum (Al), zirconium (Zr), boron (B), tungsten (W), molybdenum (Mo), chromium (Cr), niobium (Nb), magnesium (Mg), hafnium (Hf), tantalum (Ta), lanthanum (La), titanium (Ti), strontium (Sr), barium (Ba), cerium (Ce), fluorine (F), phosphorus (P), sulfur(S), and yttrium (Y), and 0.9≤x≤1.3, 0.6≤a<1.0, 0<b<0.4, 0<c<0.4, 0≤d≤0.2, and a+b+c+d=1.

According to an embodiment of the present disclosure, M¹ in Formula 1 may be a doping element that may be included in the lithium transition metal composite oxide, and may be appropriately selected as needed.

According to an embodiment of the present disclosure, in Formula 1, x is a molar ratio of lithium to transition metals in the lithium transition metal composite oxide, wherein x may be 0.9 or more, 0.95 or more, or 1.0 or more, and also, may be 1.1 or less, 1.07 or less, 1.05 or less, or 1.03 or less.

According to an embodiment of the present disclosure, in Formula 1, a, b, c, and d may be mole fractions of nickel (Ni), cobalt (Co), manganese (Mn), and the doping element (M¹) among the transition metals, respectively. As a specific example, a is the mole fraction of the nickel (Ni) among the transition metals, wherein a may be 0.6 or more, 0.7 or more, 0.8 or more, 0.85 or more, 0.88 or more, 0.90 or more, 0.91 or more, 0.92 or more, 0.93 or more, 0.94 or more, 0.95 or more, or 0.96 or more, and also, may be less than 1.0, 0.99 or less, 0.98 or less, 0.97 or less, or 0.96 or less. Also, b is the mole fraction of the cobalt (Co) among the transition metals, wherein b may be greater than 0, 0.01 or more, 0.02 or more, or 0.03 or more, and also, may be less than 0.4, 0.3 or less, 0.2 or less, 0.1 or less, 0.09 or less, 0.08 or less, 0.07 or less, 0.06 or less, or 0.05 or less. c is the mole fraction of the manganese (Mn) among the transition metals, wherein c may be greater than 0, 0.01 or more, or 0.05 or more, and also, may be less than 0.4, 0.3 or less, 0.2 or less, 0.1 or less, 0.09 or less, 0.08 or less, 0.07 or less, 0.06 or less, or 0.05 or less. d is the mole fraction of the doping element (M¹) among the transition metals, wherein d may be 0, 0.01 or more, 0.02 or more, 0.03 or more, 0.04 or more, 0.05 or more, 0.06 or more, 0.07 or more, 0.08 or more, 0.09 or more, 0.10 or more, 0.11 or more, 0.12 or more, 0.13 or more, 0.14 or more, 0.15 or more, 0.16 or more, 0.17 or more, 0.18 or more, or 0.19 or more, and also, may be less than 0.20, 0.19 or less, 0.18 or less, 0.17 or less, 0.16 or less, 0.15 or less, 0.14 or less, 0.13 or less, 0.12 or less, 0.11 or less, 0.10 or less, 0.09 or less, 0.08 or less, 0.07 or less, 0.06 or less, 0.05 or less, 0.04 or less, 0.03 or less, 0.02 or less, or 0.01 or less.

According to an embodiment of the present disclosure, the positive electrode active material may have a D₅₀ of 5 μm or more. Conventionally, when preparing a positive electrode active material in a form of a single particle, since, after a precursor in a form of a hydroxide has been mixed with a lithium compound and expanded secondary particles have been prepared by over-sintering the mixture, the secondary particles have been ground to prepare the positive electrode active material in the form of a single particle, the positive electrode active material in the form of a single particle, as a small particle having a D₅₀ of about 1 μm to 4 μm, has been prepared, and thus, there was a limit to increase the D₅₀ of the positive electrode active material in the form of a single particle. However, since the positive electrode active material according to the present disclosure is prepared by a method of preparing a positive electrode active material as described subsequently, it may have a D₅₀ of 5 μm or more while being in the form of a single particle. Since the positive electrode active material of the present disclosure has a D₅₀ of 5 μm or more while being in the form of a single particle, it may further minimize occurrence of cracks in the positive electrode active material and, in terms of improving the rolling density, it is more advantageous than the positive electrode active material in the form of a single particle, as the small particle having a D₅₀ of about 1 μm to 4 μm. That is, the positive electrode active material of the present disclosure is characterized in that it is in the form of a single particle and has a D₅₀ of 5 μm or more. As a specific example, the positive electrode active material may have a D₅₀ of 5 μm or more, 5.1 μm or more, 5.2 μm or more, 5.3 μm or more, 5.4 μm or more, 5.5 μm or more, 5.6 μm or more, 5.7 μm or more, 5.8 μm or more, 5.9 μm or more, 6.0 μm or more, 6.1 μm or more, 6.2 μm or more, 6.3 μm or more, 6.4 μm or more, 6.5 μm or more, 6.6 μm or more, 6.7 μm or more, 6.8 μm or more, 6.9 μm or more, or 7.0 μm or more. Also, the positive electrode active material, in terms of distinguishing it from a positive electrode active material in a form of a secondary particle, as a large particle with a D₅₀ of about 10 μm or more, may have a D₅₀ of 9 μm or less, 8.9 μm or less, 8.8 μm or less, 8.7 μm or less, 8.6 μm or less. 8.5 μm or less, 8.4 μm or less, 8.3 μm or less, 8.2 μm or less, 8.1 μm or less, 8.0 μm or less, 7.9 μm or less, 7.8 μm or less, 7.7 μm or less, 7.6 μm or less, 7.5 μm or less, 7.4 μm or less, 7.3 μm or less, 7.2 μm or less, 7.1 μm or less, 7.0 μm or less, or 6.5 μm or less, and, in the present disclosure, in order to distinguish the positive electrode active material having the above D₅₀ from the small particle-sized positive electrode active material and the large particle-sized positive electrode active material, the positive electrode active material may be referred to as a positive electrode active material of a medium-sized single particle.

According to an embodiment of the present disclosure, when a pellet is formed by applying a force until the force reaches 9,000 kgf using an automatic pellet press, the positive electrode active material may have a rolling density calculated by Equation 3 of 3.56 g/cm³ or more. In this case, when a positive electrode is formed by using the positive electrode active material alone or by mixing the positive electrode active material with the small particle-sized or large particle-sized positive electrode active material, porosity of the positive electrode may be further reduced by minimizing the occurrence of cracks due to rolling, and accordingly, since a larger amount of the positive electrode active material may be included in the same volume of a positive electrode active material layer, the energy density of the lithium secondary battery may be further improved.

According to an embodiment of the present disclosure, the positive electrode active material needs to have a rolling density of 3.56 g/cm³ or more. This is the minimum standard for achieving an effect according to the present disclosure, wherein the rolling density must be 3.56 g/cm³ or more to achieve the energy density according to the present disclosure. As a specific example, the positive electrode active material may have a rolling density of 3.57 g/cm³ or more, 3.58 g/cm³ or more, 3.59 g/cm³ or more, 3.60 g/cm³ or more, 3.61 g/cm³ or more, 3.62 g/cm³ or more, 3.63 g/cm³ or more, 3.64 g/cm³ or more, 3.65 g/cm³ or more, 3.66 g/cm³, or more, or 3.67 g/cm³ or more, and, since the rolling density may be significantly improved within this range during preparation of the positive electrode, the energy density of the lithium secondary battery may be increased, and, accordingly, capacity characteristics may be further improved. Also, the positive electrode active material may have a rolling density of 3.80 g/cm³ or less, 3.75 g/cm³ or less, 3.74 g/cm³ or less, 3.73 g/cm³ or less, or 3.72 g/cm³ or less.

According to an embodiment of the present disclosure, the positive electrode active material may be one in which, particularly, the cumulative distribution of volume according to the particle diameter of the positive electrode active material particle is adjusted in addition to the nickel content, the D₅₀, and the rolling density. As a specific example, with respect to the positive electrode active material, a mode in the cumulative distribution of volume according to the particle diameter of the positive electrode active material particle may be greater than the D₅₀.

In a positive electrode active material as an aggregate of a plurality of particles constituting a cumulative distribution of volume according to a particle diameter, in a case in which a mode in the cumulative distribution of volume according to the particle diameter is greater than D₅₀ as in the positive electrode active material of the present disclosure, since an amount of fine powder having a relatively small particle diameter is high, pores between positive electrode active material particles may be minimized when a positive electrode active material layer is formed by using the positive electrode active material, and, accordingly, a larger amount of the positive electrode active material particles may be included in the same volume to ensure higher energy density. Thus, even if the positive electrode active material has the same D₅₀, since the energy density varies depending on a difference between the mode and the D₅₀ in the cumulative distribution of volume according to the particle diameter, it is important to control this and the positive electrode active material according to the present application may further improve the energy density of the lithium secondary battery by adjusting the mode in the cumulative distribution of volume according to the particle diameter to be greater than the D₅₀, in addition to the nickel content, D₅₀, and rolling density.

According to an embodiment of the present disclosure, the positive electrode active material may have a negative skewness value calculated by Equation 1 below of greater than 0.

$$Negative skewness = ( Mode - {D}_{10} ) / {D}_{50} \qquad [ Equation 1 ]$$

Typically, s is a statistical measure of asymmetry of a specific distribution, wherein, if a skewness value is positive, it is indicated as positive skewness, and, if the skewness value is negative, it is indicated as negative skewness. However, since the positive skewness and negative skewness expressed by a conventional method are expressed in the form of a cube of deviation from an average, the skewness value becomes larger as the skewness is increased, and thus, it is not appropriate to determine the amount of the fine powder of the positive electrode active material in the present disclosure. Therefore, in the present disclosure, the negative skewness is newly defined and represented by Equation 1 above. According to Equation 1 above, the negative skewness in the present disclosure is expressed as a ratio of a difference between the mode and D₁₀ to the D₅₀. The amount of the fine powder of the positive electrode active material, as the aggregate of the plurality of particles constituting the cumulative distribution of volume according to the particle diameter, may be indirectly confirmed by comparing the difference between the mode and the D₁₀ corresponding to a fine powder region based on the D₅₀.

According to an embodiment of the present disclosure, the positive electrode active material may have a negative skewness value calculated by Equation 1 of greater than 0, 0.10 or more, 0.20 or more, 0.30 or more, 0.40 or more, or 0.45 or more, and, also, of 0.75 or less, 0.70 or less, 0.65 or less, 0.60 or less, 0.59 or less, 0.58 or less, 0.57 or less, 0.56 or less, or 0.55 or less, and, within this range, it is possible to minimize the cracks caused by the pressure during the rolling for the preparation of the electrode, maximize the energy density of the lithium secondary battery, and secure the capacity characteristics by appropriately adjusting the amount of the fine powder having a relatively small particle diameter.

According to an embodiment of the present disclosure, the positive electrode active material may have a mode in the cumulative distribution of volume according to the particle diameter of 5.5 μm or more, 5.6 μm or more, 5.7 μm or more, 5.8 μm or more, 5.9 μm or more, 6.0 μm or more, 6.1 μm or more, 6.2 μm or more, 6.3 μm or more, 6.4 μm or more, 6.5 μm or more, 6.6 μm or more, 6.7 μm or more, 6.8 μm or more, 6.9 μm or more, 7.0 μm or more, 7.1 μm or more, 7.2 μm or more, 7.3 μm or more, 7.4 μm or more, or 7.5 μm or more, and, also, of 9.5 μm or less, 9.4 μm or less, 9.3 μm or less, 9.2 μm or less, 9.1 μm or less, 9.0 μm or less, 8.9 μm or less, 8.8 μm or less, 8.7 μm or less, 8.6 μm or less, 8.5 μm or less, 8.4 μm or less, 8.3 μm or less, 8.2 μm or less, 8.1 μm or less, 8.0 μm or less, 7.9 μm or less, 7.8 μm or less, 7.7 μm or less, 7.6 μm or less, 7.5 μm or less, or 7.0 μm or less, and, within this range, in addition to the nickel content, D₅₀, and rolling density, the energy density of the lithium secondary battery may be further improved.

According to an embodiment of the present disclosure, the positive electrode active material may have a D₁₀ in the cumulative distribution of volume according to the particle diameter of 3.0 μm or more, 3.1 μm or more, 3.2 μm or more, 3.3 μm or more, 3.4 μm or more, or 3.5 μm or more, and, also, of 6.0 μm or less, 5.5 μm or less, or 5.0 μm or less, and the energy density of the lithium secondary battery may be further improved by adjusting a fine powder size within this range.

According to an embodiment of the present disclosure, the positive electrode active material may have a difference between the mode and the D₅₀ of 1.0 μm or less, 0.9 μm or less, 0.8 μm or less, 0.7 μm or less, 0.6 μm or less, or 0.5 μm or less, and, also, of 0.1 μm or more, 0.2 μm or more, 0.3 μm or more, or 0.4 μm or more, and, within this range, in addition to the nickel content, D₅₀, and rolling density, the energy density of the lithium secondary battery may be further improved.

### Method of Preparing Positive Electrode Active Material

The present disclosure provides a method of preparing a positive electrode active material which is for preparing the above positive electrode active material.

According to an embodiment of the present disclosure, the method of preparing a positive electrode active material includes the steps of: mixing a positive electrode active material precursor, which contains nickel, cobalt, and manganese and contains 60 mol % or more of the nickel among transition metals, and a lithium raw material and performing primary sintering to prepare a pre-sintered product (S10); sintering on the pre-sintered and performing secondary product prepared in step (S10) to prepare a lithium transition metal composite oxide in a form of a single particle (S20), wherein the secondary sintering may be performed at a lower temperature than the primary sintering.

As described above, since the secondary sintering is performed at a lower temperature than the primary sintering, a positive electrode active material having a D₅₀ of 5 μm or more and a rolling density calculated by Equation 3 of 3.56 g/cm³ or more, when a pellet is formed by applying a force until the force reaches 9,000 kgf using an automatic pellet press, may be prepared.

According to an embodiment of the present disclosure, a temperature difference between the primary sintering of step (S10) and the secondary sintering of step (S20) may be 10° C. or higher, 20° C. or higher, 30° C. or higher, 40° C. or higher, or 50° C. or higher, and also, may be 300° C. or less, 250° C. or less, 200° C. or less, 150° C. or less, or 100° C. or less. As a specific example, the primary sintering of step (S10) may be performed at a temperature of 800° C. to 1,000° C., and, as a more specific example, the primary sintering of step (S10) may be performed in a temperature range of 800° C. to 1,000° C., 830° C. to 950° C., or 850° C. to 900° C. Also, the secondary sintering of step (S20) may be performed at a temperature of 600° C. to 900° C., and, as a more specific example, the secondary sintering of step (S20) may be performed in a temperature range of 600° C. to 900° C., 650° C. to 850° C., or 700° C. to 800° C.

According to an embodiment of the present disclosure, in the pre-sintered product prepared by the primary sintering of step (S10), since particles may be aggregated with each other, the secondary sintering of step (S20) may be performed on a form of a ground product by grinding the pre-sintered product prepared in step (S10).

According to an embodiment of the present disclosure, the positive electrode active material precursor, which contains nickel, cobalt, and manganese and contains 60 mol % or more of the nickel among the transition metals, may be a transition metal hydroxide or a transition metal oxide. As a specific example, the transition metal hydroxide may have an average composition represented by Formula 2 below, and the transition metal oxide may have an average composition represented by Formula 3 below.

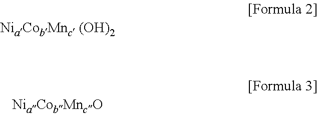

In Formula 2, 0.6≤a′<1.0, 0<b′<0.4, 0<c′<0.4, and a′+b′+c′=1, and, in Formula 3, 0.6≤a″<1.0, 0<b″<0.4, 0<c″<0.4, and a″+b″+c″=1.

According to an embodiment of the present disclosure, in Formulae 2 and 3, a′, a″, b′, b″, c′, and c″ may be mole fractions of nickel (Ni), cobalt (Co), and manganese (Mn) among transition metals, respectively. As a specific example, a′ or a″ is the mole fraction of the nickel (Ni) among the transition metals, wherein a′ or a″ may be 0.6 or more, 0.7 or more, 0.8 or more, 0.85 or more, 0.88 or more, 0.90 or more, 0.91 or more, 0.92 or more, 0.93 or more, 0.94 or more, 0.95 or more, or 0.96 or more, and, also, may be less than 1.0, 0.99 or less, 0.98 or less, 0.97 or less, or 0.96 or less. Also, b′ or b″ is the mole fraction of the cobalt (Co) among the transition metals, wherein b′ or b″ may be greater than 0, 0.01 or more, 0.02 or more, or 0.03 or more, and, also, may be less than 0.4, 0.3 or less, 0.2 or less, 0.1 or less, 0.09 or less, 0.08 or less, 0.07 or less, 0.06 or less, or 0.05 or less. Furthermore, c′ or c″ is the mole fraction of the manganese (Mn) among the transition metals, wherein c′ or c″ may be greater than 0, 0.01 or more, or 0.05 or more, and, also, may be less than 0.4, 0.3 or less, 0.2 or less, 0.1 or less, 0.09 or less, 0.08 or less, 0.07 or less, 0.06 or less, or 0.05 or less.

According to an embodiment of the present disclosure, the transition metal oxide may be prepared by sintering the transition metal hydroxide. As a specific example, the transition metal oxide may be prepared from a step of sintering a transition metal hydroxide, which contains nickel, cobalt, and manganese and contains 60 mol % or more of the nickel among transition metals, in an air or oxygen atmosphere (S1). In this case, the sintering in step (S1) may be performed at a temperature of 800° C. or higher, as a specific example, may be performed at a temperature of 800° C. or higher, 850° C. or higher, 900° C. or higher, 950° C. or higher, or 1,000° C. or higher, and, also, may be performed at a temperature of 1,200° C. or less, 1,150° C. or less, 1, 100° C. or less, or 1,050° C. or less.

According to an embodiment of the present disclosure, it may be more desirable to use the transition metal oxide as the positive electrode active material precursor, which contains nickel, cobalt, and manganese and contains 60 mol % or more of the nickel among the transition metals, from the viewpoint of securing higher rolling density for the positive electrode active material of a medium-sized single particle according to the present disclosure.

According to an embodiment of the present disclosure, step (S1) may be performed by including the steps of: mixing a transition metal hydroxide and a doping raw material (S1-1); and preparing a transition metal oxide by sintering the mixture mixed in step (S1-1) in an air or oxygen atmosphere (S1-2). In this case, the doping raw material may include at least one doping element selected from a group consisting of Li, Al, Zr, B, W, Mo, Cr, Nb, Mg, Hf, Ta, La, Ti, Sr, Ba, Ce, F, P, S, and Y.

According to an embodiment of the present disclosure, during the mixing of the positive electrode active material precursor and the lithium raw material in step (S10), a molar ratio (Li/M) of lithium (Li) of the lithium raw material to the transition metals (M) of the positive electrode active material precursor may be in a range of 0.9 to 1.3. As a specific example, the Li/M may be 0.9 or more, 0.95 or more, or 1.0 or more, and also, may be 1.1 or less, 1.07 or less, 1.05 or less, or 1.03 or less, and the Li/M may be adjusted depending on a nickel content in the transition metals.

### Positive Electrode

The present disclosure provides a positive electrode including the positive electrode active material.

According to an embodiment of the present disclosure, the positive electrode may include a positive electrode collector and a positive electrode active material layer formed on the positive electrode collector, wherein the positive electrode active material layer may include the above positive electrode active material.

According to an embodiment of the present disclosure, the positive electrode collector may include a metal having high conductivity, and is not particularly limited as long as it has no reactivity in a voltage range of the battery and the positive electrode active material layer is easily adhered thereto. As the positive electrode collector, for example, stainless steel, aluminum, nickel, titanium, fired carbon, or aluminum or stainless steel that is surface-treated with one of carbon, nickel, titanium, silver, or the like may be used. Also, the positive electrode collector may typically have a thickness of 3 μm to 500 μm, and microscopic irregularities may be formed on the surface of the collector to improve the adhesion of the positive electrode active material. The positive electrode collector, for example, may be used in various shapes such as that of a film, a sheet, a foil, a net, a porous body, a foam body, a non-woven fabric body, and the like.

According to an embodiment of the present disclosure, the positive electrode active material layer may optionally include a conductive agent and a binder in addition to the positive electrode active material, if necessary. In this case, the positive electrode active material may be included in an amount of 80 wt % to 99 wt %, for example, 85 wt % to 98.5 wt % based on a total weight of the positive electrode active material layer, and excellent capacity characteristics may be obtained within this range.

According to an embodiment of the present disclosure, the conductive agent is used to provide conductivity to the electrode, wherein any conductive agent may be used without particular limitation as long as it has suitable electron conductivity without causing adverse chemical changes in the battery. Specific examples of the conductive agent may be graphite such as natural graphite or artificial graphite; carbon based materials such as carbon black, acetylene black, Ketjen black, channel black, furnace black, lamp black, thermal black, and carbon fibers; powder or fibers of metal such as copper, nickel, aluminum, and silver; conductive tubes such as carbon nanotubes; conductive whiskers such as zinc oxide and whiskers potassium titanate whiskers; conductive metal oxides such as titanium oxide; or conductive polymers such as polyphenylene derivatives, and any one thereof or a mixture of two or more thereof may be used. The conductive agent may be included in an amount of 0.1 wt % to 15 wt % based on the total weight of the positive electrode active material layer.

According to an embodiment of the present disclosure, the binder improves the adhesion between positive electrode active material particles and the adhesion between the positive electrode active material and the current collector. Specific examples of the binder may be polyvinylidene fluoride (PVDF), polyvinylidene fluoride-hexafluoropropylene copolymer (PVDF-co-HFP), polyvinyl alcohol, polyacrylonitrile, polymethylmethacrylate, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene polymer (EPDM), a sulfonated EPDM, a styrene-butadiene rubber (SBR), a fluorine rubber, poly acrylic acid, and a polymer having hydrogen thereof substituted with lithium (Li), sodium (Na), or calcium (Ca), or various copolymers thereof, and any one thereof or a mixture of two or more thereof may be used. The binder may be included in an amount of 0.1 wt % to 15 wt % based on the total weight of the positive electrode active material layer.

According to an embodiment of the present disclosure, the positive electrode may be prepared according to a typical method of preparing a positive electrode except that the above-described positive electrode active material is used. Specifically, a composition for forming a positive electrode active material layer, which is prepared by dissolving or dispersing the positive electrode active material as well as optionally the binder and the conductive agent in a solvent, is coated on the positive electrode collector, and the positive electrode may then be prepared by drying and rolling the coated positive electrode collector, or the positive electrode may be prepared by casting the composition for forming a positive electrode active material layer on a separate support and then laminating a film separated from the support on the positive electrode collector.

According to an embodiment of the present disclosure, the solvent may be a solvent normally used in the art, and may include dimethyl sulfoxide (DMSO), isopropyl alcohol, N-methylpyrrolidone (NMP), dimethyl formamide (DMF), acetone, or water, and any one thereof or a mixture of two or more thereof may be used. An amount of the solvent used may be sufficient if the solvent may dissolve or disperse the positive electrode active material, the conductive agent, the binder, and the dispersant in consideration of a coating thickness of a slurry and manufacturing yield, and may allow to have a viscosity that may provide excellent thickness uniformity during the subsequent coating for the preparation of the positive electrode.

### Lithium Secondary Battery

The present disclosure provides a lithium secondary battery including the positive electrode.

According to an embodiment of the present disclosure, the lithium secondary battery may include the positive electrode; a negative electrode; a separator disposed between the positive electrode and the negative electrode, and an electrolyte. Also, the lithium secondary battery may further optionally include a battery container accommodating an electrode assembly of the positive electrode, the negative electrode, and the separator, and a sealing member sealing the battery container.

According to an embodiment of the present disclosure, the negative electrode may include a negative electrode collector and a negative electrode active material layer disposed on the negative electrode collector.

According to an embodiment of the present disclosure, the negative electrode collector is not particularly limited as long as it has high conductivity without causing adverse chemical changes in the battery, and, for example, copper, stainless steel, aluminum, nickel, titanium, fired carbon, copper or stainless steel that is surface-treated with one of carbon, nickel, titanium, silver, or the like, and an aluminum-cadmium alloy may be used. Also, the negative electrode collector may typically have a thickness of 3 μm to 500 μm, and, similar to the positive electrode collector, microscopic irregularities may be formed on the surface of the collector to improve the adhesion of a negative electrode active material. The negative electrode collector, for example, may be used in various shapes such as that of a film, a sheet, a foil, a net, a porous body, a foam body, a non-woven fabric body, and the like.

According to an embodiment of the present disclosure, the negative electrode active material layer may optionally include a binder and a conductive agent in addition to the negative electrode active material.

According to an embodiment of the present disclosure, a compound capable of reversibly intercalating and deintercalating lithium may be used as the negative electrode active material. Specific examples of the negative electrode active material may be a carbonaceous material such as artificial graphite, natural graphite, graphitized carbon fibers, and amorphous carbon; a metallic compound alloyable with lithium such as silicon (Si), aluminum (Al), tin (Sn), lead (Pb), zinc (Zn), bismuth (Bi), indium (In), magnesium (Mg), gallium (Ga), cadmium (Cd), a Si alloy, a Sn alloy, or an Al alloy; a metal oxide which may be doped and undoped with lithium such as SiO_{β} (0<β<2), SnO₂, vanadium oxide, and lithium vanadium oxide; or a composite including the metallic compound and the carbonaceous material such as a Si—C composite or a Sn—C composite, and any one thereof or a mixture of two or more thereof may be used. Also, a metallic lithium thin film may be used as the negative electrode active material. Furthermore, both low crystalline carbon and high crystalline carbon may be used as the carbon material. Typical examples of the low crystalline carbon may be soft carbon and hard carbon, and typical examples of the high crystalline carbon may be irregular, planar, flaky, spherical, or fibrous natural graphite or artificial graphite, Kish graphite, pyrolytic carbon, mesophase pitch-based carbon fibers, meso-carbon microbeads, mesophase pitches, and high-temperature sintered carbon such as petroleum or coal tar pitch derived cokes. The negative electrode active material may be included in an amount of 80 wt % to 99 wt % based on a total weight of the negative electrode active material layer.

According to an embodiment of the present disclosure, the binder of the negative electrode active material layer is a component that assists in the binding between the conductive agent, the active material, and the current collector, wherein the binder is typically added in an amount of 0.1 wt % to 10 wt % based on the total weight of the negative electrode active material layer. Examples of the binder may be polyvinylidene fluoride (PVDF), polyvinyl alcohol, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene polymer (EPDM), a sulfonated-EPDM, a styrene-butadiene rubber, a nitrile-butadiene rubber, a fluorine rubber, and various copolymers thereof.

According to an embodiment of the present disclosure, the conductive agent of the negative electrode active material layer is a further improving component for conductivity of the negative electrode active material, wherein the conductive agent may be added in an amount of 10 wt % or less, for example, 5 wt % or less based on the total weight of the negative electrode active material layer. The conductive agent is not particularly limited as long as it has conductivity without causing adverse chemical changes in the battery, and, for example, a conductive material, such as: graphite such as natural graphite or artificial graphite; carbon black such as acetylene black, Ketjen black, channel black, and thermal black; black, furnace black, lamp conductive fibers such as carbon fibers or metal fibers; fluorocarbon; metal powder such as aluminum powder and nickel powder; conductive whiskers such as zinc oxide whiskers and potassium titanate whiskers; conductive metal oxide such as titanium oxide; or polyphenylene derivatives, may be used.

According to an embodiment of the present disclosure, the negative electrode may be prepared by coating a composition for forming a negative electrode active material layer, which is prepared by dissolving or dispersing optionally the binder and the conductive agent as well as the negative electrode active material in a solvent, on the negative electrode collector and drying the coated negative electrode collector, or may be prepared by casting the composition for forming a negative electrode active material layer on a separate support and then laminating a film separated from the support on the negative electrode collector.

According to an embodiment of the present disclosure, the separator separates the negative electrode and the positive electrode and provides a movement path of lithium ions, wherein any separator may be used as the separator without particular limitation as long as it is typically used in a lithium secondary battery, and particularly, a separator having high moisture-retention ability for an electrolyte as well as low resistance to the transfer of electrolyte ions may be used. Specifically, porous polymer film, for example, a porous polymer film prepared from a polyolefin-based polymer, such as an ethylene homopolymer, a propylene homopolymer, an ethylene/butene copolymer, an ethylene/hexene copolymer, and an ethylene/methacrylate copolymer, or a laminated structure having two or more layers thereof may be used. Also, a typical porous nonwoven fabric, for example, a nonwoven fabric formed of high melting point glass fibers or polyethylene terephthalate fibers may be used. Furthermore, a coated separator including a ceramic component or a polymer material may be used to secure heat resistance or mechanical strength, and the separator having a single layer or multilayer structure may be optionally used.

According to an embodiment of the present disclosure, the electrolyte may include an organic liquid electrolyte, an inorganic liquid electrolyte, a solid polymer electrolyte, a gel-type polymer electrolyte, a solid inorganic electrolyte, or a molten-type inorganic electrolyte which may be used in the preparation of the lithium secondary battery, but the present disclosure is not limited thereto. As a specific example, the electrolyte may include an organic solvent and a lithium salt.

According to an embodiment of the present disclosure, any organic solvent may be used as the organic solvent without particular limitation so long as it may function as a medium through which ions involved in an electrochemical reaction of the battery may move. Specifically, an ester-based solvent such as methyl acetate, ethyl acetate, Y-butyrolactone, and E-caprolactone; an ether-based solvent such as dibutyl ether or tetrahydrofuran; a ketone-based solvent such as cyclohexanone; an aromatic hydrocarbon-based solvent such as benzene and fluorobenzene; or a carbonate-based solvent such as dimethyl carbonate (DMC), diethyl carbonate (DEC), methylethyl carbonate (MEC), ethylmethyl carbonate (EMC), ethylene carbonate (EC), and propylene carbonate (PC); an alcohol-based solvent such as ethyl alcohol and isopropyl alcohol; nitriles such as R—CN (where R is a linear, branched, or cyclic C2-C20 hydrocarbon group and may include a double-bond aromatic ring or ether bond); amides such as dimethylformamide; dioxolanes such as 1,3-dioxolane; or sulfolanes may be used as the organic solvent. Among these solvents, the carbonate-based solvent is preferable, and a mixture of a cyclic carbonate (e.g., ethylene carbonate or propylene carbonate) having high ionic conductivity and high dielectric constant, which may increase charge/discharge performance of the battery, and a low-viscosity linear carbonate-based compound (e.g., ethylmethyl carbonate, dimethyl carbonate, or diethyl carbonate) is more preferable.

According to an embodiment of the present disclosure, the lithium salt may be used without particular limitation as long as it is a compound capable of providing lithium ions used in the lithium secondary battery. Specifically, an anion of the lithium salt may be at least one selected from the group consisting of F⁻, Cl⁻, Br⁻, I⁻, NO₃⁻, N(CN)₂⁻, BF₄⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻, and LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, or LiB(C₂O₄)₂ may be used as the lithium salt. The lithium salt may be used in a concentration range of 0.1 M to 2.0 M. If the concentration of the lithium salt is included within the above range, since the electrolyte may have appropriate conductivity and viscosity, excellent performance of the electrolyte may be obtained, and lithium ions may effectively move.

According to an embodiment of the present disclosure, in order to improve life characteristics of the battery, suppress the reduction in battery capacity, and improve discharge capacity of the battery, at least one additive, for example, a halo-alkylene carbonate-based compound such as difluoroethylene carbonate, pyridine, triethylphosphite, triethanolamine, cyclic ether, ethylenediamine, n-glyme, hexaphosphorictriamide, a nitrobenzene derivative, sulfur, a quinone imine dye, N-substituted oxazolidinone, N, N-substituted imidazolidine, ethylene glycol dialkyl ether, an ammonium salt, pyrrole, 2-methoxy ethanol, or aluminum trichloride, may be further included in the electrolyte in addition to the above electrolyte components. In this case, the additive may be included in an amount of 0.1 wt % to 5 wt % based on a total weight of the electrolyte.

Since the lithium secondary battery including the positive electrode active material according to the present disclosure stably exhibits excellent capacity characteristics, output characteristics, and life characteristics, the lithium secondary battery is suitable for portable devices, such as mobile phones, notebook computers, and digital cameras, and electric cars such as hybrid electric vehicles (HEVs) and electric vehicles (EVs).

A shape of the lithium secondary battery of the present disclosure is not particularly limited, but a cylindrical type using a can, a prismatic type, a pouch type, or a coin type may be used.

The lithium secondary battery according to the present disclosure may not only be used in a battery cell that is used as a power source of a small device, but may also be used as a unit cell in a medium and large sized battery module including a plurality of battery cells.

Thus, according to an embodiment of the present disclosure, a battery module including the lithium secondary battery as a unit cell and a battery pack including the battery module are provided.

According to an embodiment of the present disclosure, the battery module or the battery pack may be used as a power source of at least one medium and large sized device of a power tool; electric cars including an electric vehicle (EV), a hybrid electric vehicle, and a plug-in hybrid electric vehicle (PHEV); or a power storage system.

Hereinafter, examples of the present disclosure will be described in detail in such a manner that it may easily be carried out by a person with ordinary skill in the art to which the present disclosure pertains. The disclosure may, however, be embodied in many different forms and should not be construed as being limited to the examples set forth herein.

### Examples and Comparative Examples

### Example 1

A transition metal composite hydroxide (D₅₀: 7 μm) having a composition represented by Ni_{0.96}Co_{0.03}Mn_{0.01}(OH)₂ was sintered at 1,020° C. for 9 hours in an air atmosphere to prepare a transition metal composite oxide having a composition represented by Ni_{0.96}Co_{0.03}Mn_{0.01}O.

The prepared transition metal composite oxide and LiOH were mixed such that a molar ratio (Li/Me) of lithium (Li) to transition metals (Me) was 1, and the mixture was primarily sintered at 800° C. for 12 hours in an oxygen atmosphere, then ground using a jet mill, and secondarily sintered at 700° C. for 12 hours in an oxygen atmosphere to prepare a positive electrode active material as a lithium transition metal composite oxide in a form of a single particle which had a composition represented by LiNi_{0.96}Co_{0.03}Mn_{0.01}O₂.

### Example 2

A positive electrode active material, as a lithium transition metal composite oxide in a form of a single particle which had a composition represented by LiNi_{0.96}CO_{0.03}Mn^{0.01}O₂, was prepared in the same manner as in Example 1 except that, in Example 1, the primary sintering was performed at 850° C. instead of 800° C.

### Example 3

A positive electrode active material, as a lithium transition metal composite oxide in a form of a single particle which had a composition represented by LiNi_{0.96}CO_{0.03}Mn_{0.01}O₂, was prepared in the same manner as in Example 1 except that, in Example 1, the secondary sintering was performed at 750° C. instead of 700° C.

### Example 4

A transition metal composite hydroxide (D₅₀: 9 μm) having a composition represented by Ni_{0.89}Co_{0.03}Mn_{0.08}(OH)₂ was sintered at 1,020° C. for 9 hours in an air atmosphere to prepare a transition metal composite oxide having a composition represented by Ni_{0.89}Co_{0.03}Mn_{0.08}O.

The prepared transition metal composite oxide and LiOH were mixed such that a molar ratio (Li/Me) of lithium (Li) to transition metals (Me) was 1, and the mixture was primarily sintered at 900° C. for 12 hours in an oxygen atmosphere, then ground using a jet mill, and secondarily sintered at 800° C. for 12 hours in an oxygen atmosphere to prepare a positive electrode active material as a lithium transition metal composite oxide in a form of a single particle which had a composition represented by LiNi_{0.89}Co_{0.03}Mn_{0.08}O₂.

### Example 5

A transition metal composite hydroxide (D₅₀: 7 μm) having a composition represented by Ni_{0.96}Co_{0.03}Mn_{0.01}(OH)₂ was sintered at 1,020° C. for 9 hours in an air atmosphere to prepare a transition metal composite oxide having a composition represented by Ni_{0.96}Co_{0.03}Mn_{0.01}O.

The prepared transition metal composite oxide and LiOH were mixed such that a molar ratio (Li/Me) of lithium (Li) to transition metals (Me) was 1.05, and the mixture was primarily sintered at 800° C. for 12 hours in an oxygen atmosphere, then ground using a jet mill, and secondarily sintered at 700° C. for 12 hours in an oxygen atmosphere to prepare a positive electrode active material as a lithium transition metal composite oxide in a form of a single particle which had a composition represented by Li_{1.05}Ni_{0.96}CO_{0.03}Mn_{0.01}O₂.

### Example 6

A transition metal composite hydroxide (D₅₀: 7 μm) having a composition represented by Ni_{0.96}Co_{0.03}Mn_{0.01}(OH)₂ and LiOH were mixed such that a molar ratio (Li/Me) of lithium (Li) to transition metals (Me) was 1, and the mixture was primarily sintered at 830° C. for 12 hours in an oxygen atmosphere, then ground using a jet mill, and secondarily sintered at 770° C. for 12 hours in an oxygen atmosphere to prepare a positive electrode active material as a lithium transition metal composite oxide in a form of a single particle which had a composition represented by LiNi_{0.96}CO_{0.03}Mn_{0.01}O₂.

### Example 7

A transition metal composite hydroxide (D₅₀: 4.5 μm) having a composition represented by Ni_{0.885}Co_{0.035}Mn_{0.08}(OH)₂ and LiOH were mixed such that a molar ratio (Li/Me) of lithium (Li) to transition metals (Me) was 1, and the mixture was primarily sintered at 900° C. for 12 hours in an oxygen atmosphere, then ground using a jet mill, and secondarily sintered at 800° C. for 12 hours in an oxygen atmosphere to prepare a positive electrode active material as a lithium transition metal composite oxide in a form of a single particle which had a composition represented by LiNi_{0.885}Co_{0.035}Mn_{0.08}O₂.

### Comparative Example 1

A positive electrode active material, as a lithium transition metal composite oxide in a form of a single particle which had a composition represented by LiNi_{0.96}Co_{0.03}Mn_{0.01}O₂, was prepared in the same manner as in Example 1 except that, in Example 1, the primary sintering was performed at 700° C. instead of 800° C., and the secondary sintering was performed at 800° C. instead of 700° C.

### Comparative Example 2

A positive electrode active material, as a lithium transition metal composite oxide in a form of a single particle which had a composition represented by LiNi_{0.96}Co_{0.03}Mn_{0.01}O₂, was prepared in the same manner as in Example 1 except that, in Example 1, the primary sintering was performed at 1,020° C. instead of 800° C.

### Comparative Example 3

A positive electrode active material, as a lithium transition metal composite oxide in a form of a single particle which had a composition represented by LiNi_{0.96}Co_{0.03}Mn_{0.01}O₂, was prepared in the same manner as in Example 6 except that, in Example 6, the primary sintering was performed at 770° C. instead of 830° C.

### Comparative Example 4

A positive electrode active material, as a lithium transition metal composite oxide in a form of a single particle which had a composition represented by LiNi_{0.885}Co_{0.035}Mn_{0.08}O₂, was prepared in the same manner as in Example 7 except that, in Example 7, the primary sintering was performed at 850° C. instead of 900° C.

### Experimental Examples

### Experimental Example 1: SEM Imaging and Analysis of Cumulative Distribution of Volume According to Particle Diameter

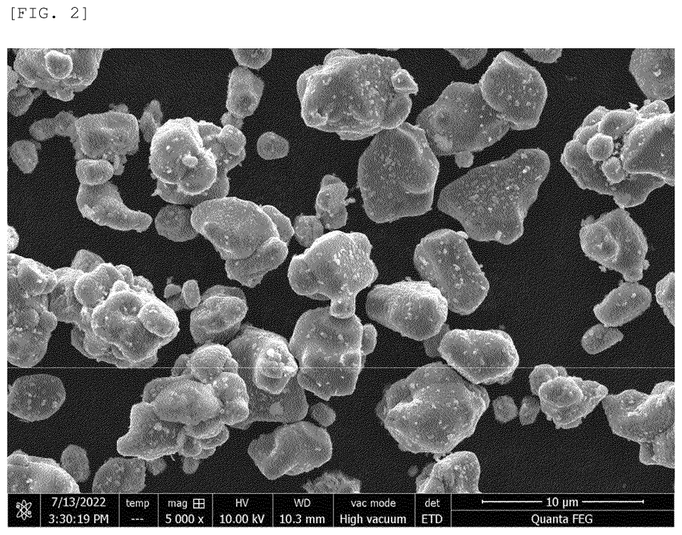

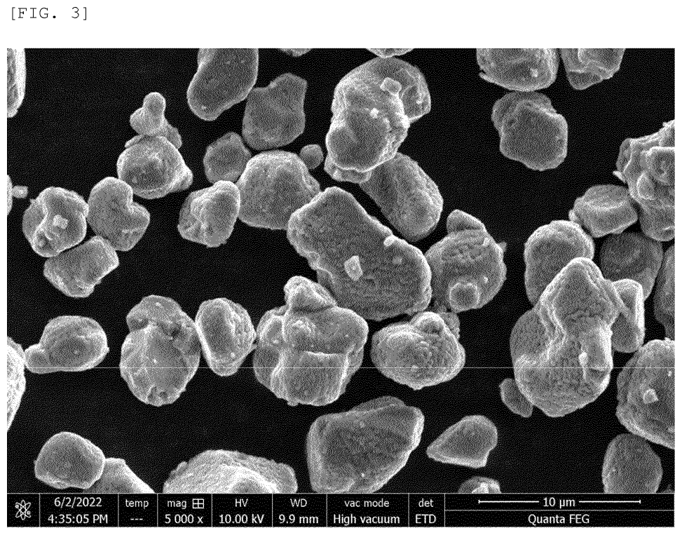

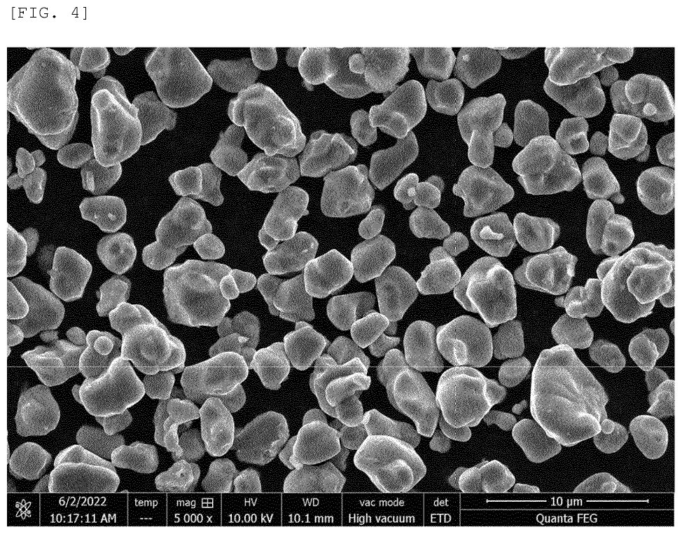

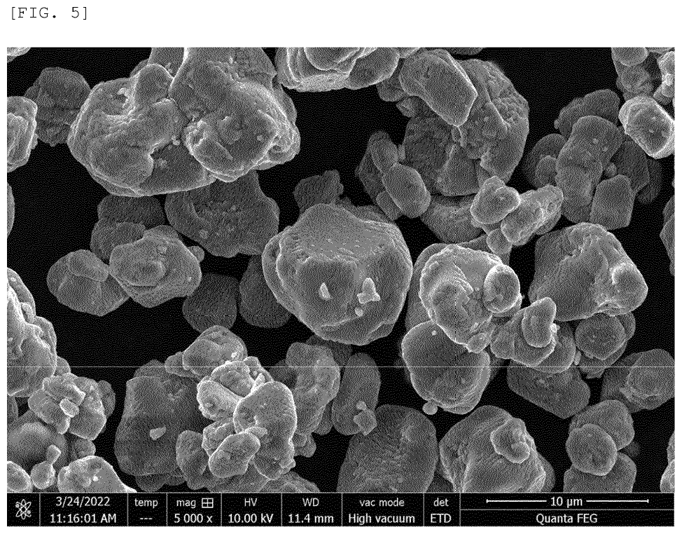

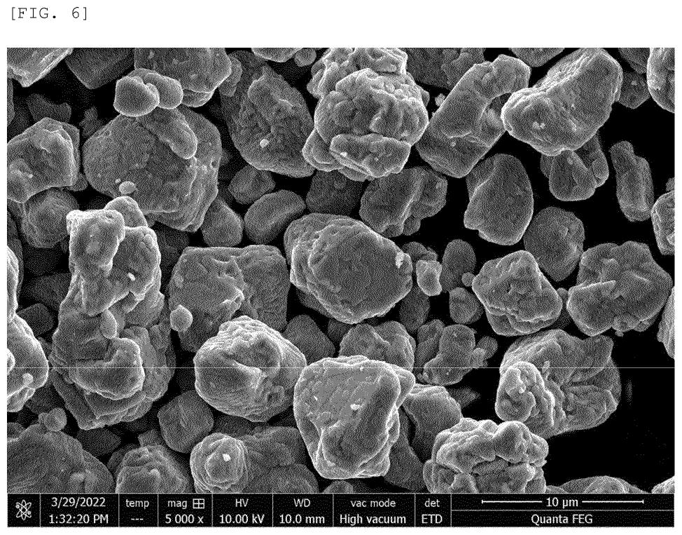

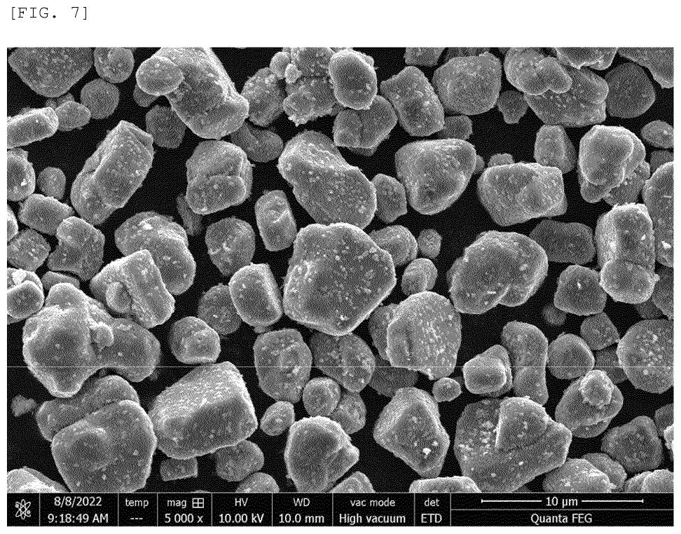

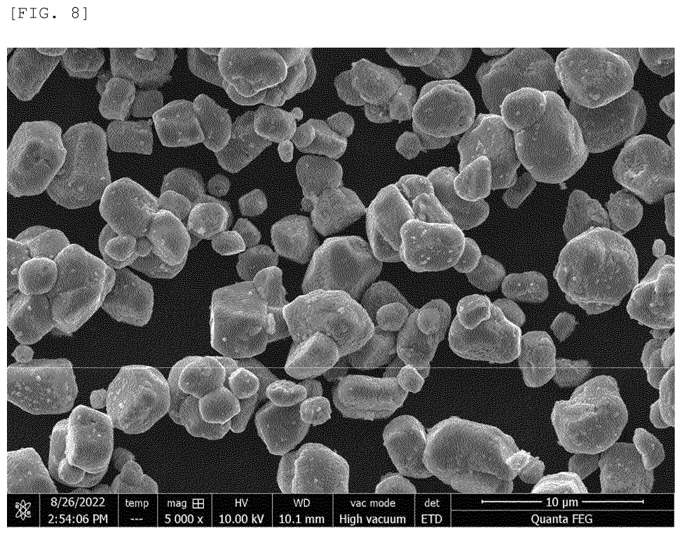

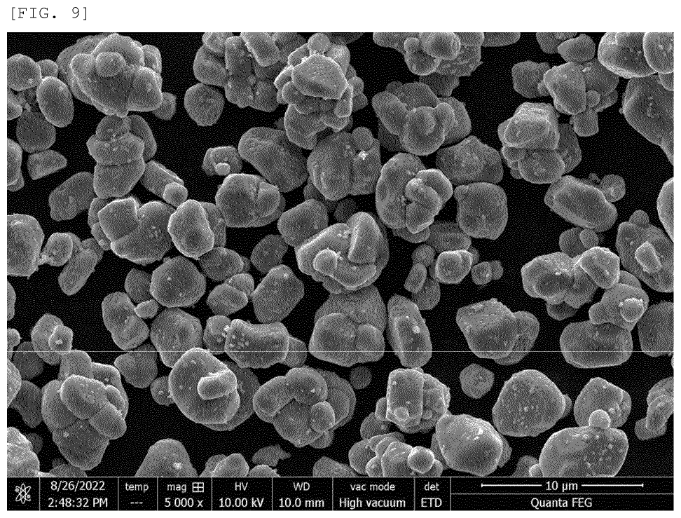

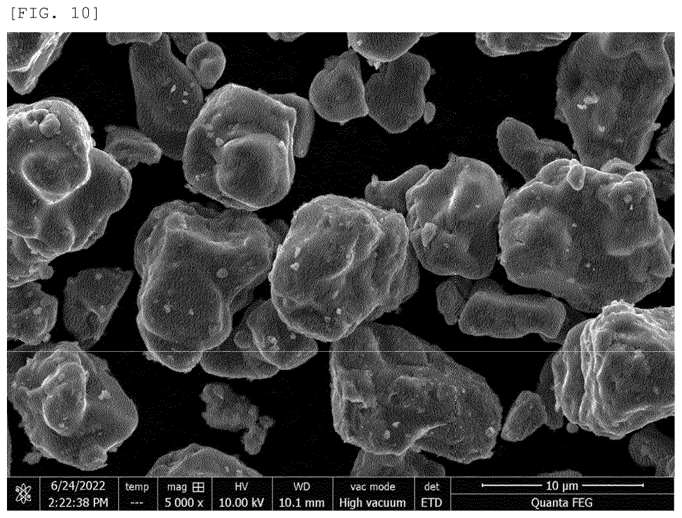

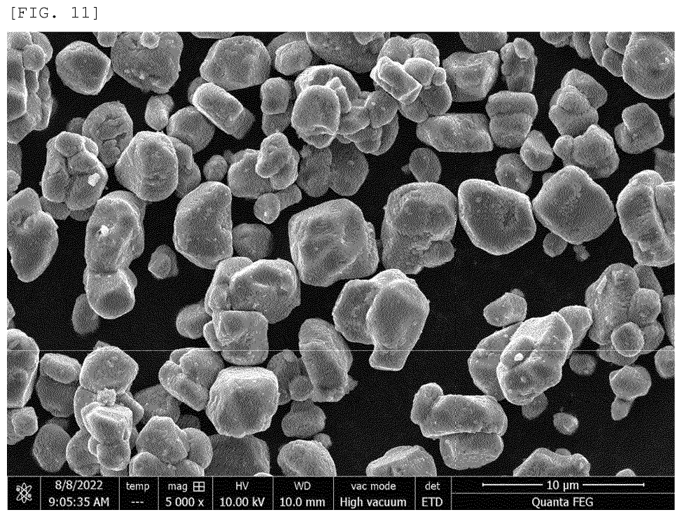

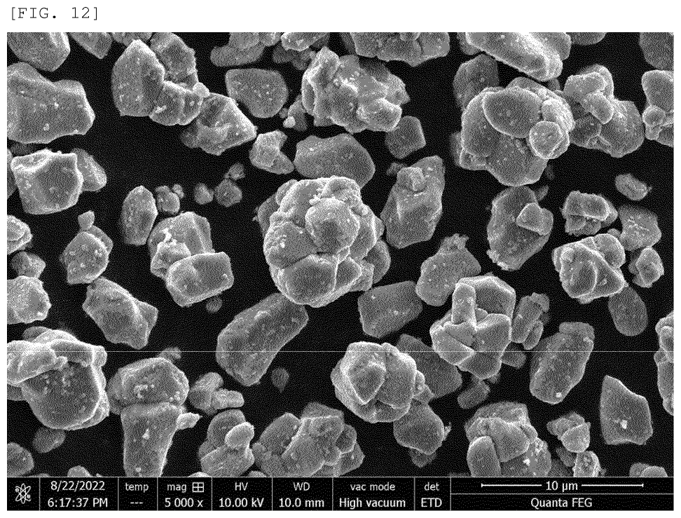

Each of the positive electrode active material precursors, as transition metal complex oxides and transition metal composite hydroxides before mixing with the lithium compound during the preparation of the positive electrode active materials of Examples 1 to 7 and Comparative Examples 1 to 4, and the positive electrode active materials prepared in Examples 1 to 7 and Comparative Examples 1 to 4 were imaged using a scanning electron microscope (SEM, FEI, Inspect F), and these images are illustrated in FIGS. 2 to 12, respectively.

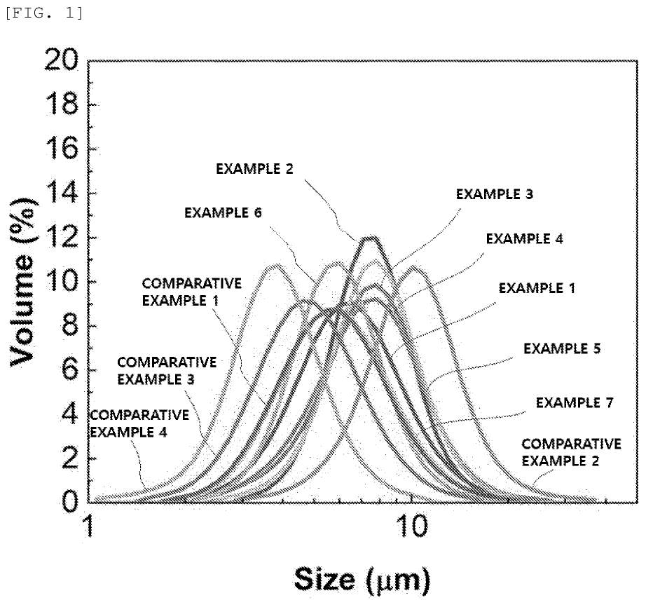

Also, for the positive electrode active materials prepared in Examples 1 to 7 and Comparative Examples 1 to 4, D₁₀, D₅₀, D₉₀, and a mode in a cumulative distribution of volume according to a particle diameter were measured using a particle size analyzer (PSD, Malvern Panalytical Ltd., martersizer 3000) and illustrated in FIG. 1 and Table 1, and a negative skewness value was calculated using Equation 1 below and presented together in Table 1 below.

$$Negative skewness = ( Mode - {D}_{10} ) / {D}_{50} \qquad [ Equation 1 ]$$

TABLE 1

| | D₁₀ | D₅₀ | D₉₀ | Mode | Negative |
|---|---|---|---|---|---|
| Category | (μm) | (μm) | (μm) | (μm) | skewness |
| Example 1 | 3.18 | 6.14 | 10.21 | 6.54 | 0.547 |
| Example 2 | 4.94 | 7.19 | 10.57 | 7.78 | 0.395 |
| Example 3 | 4.32 | 7.20 | 11.39 | 7.78 | 0.481 |
| Example 4 | 3.54 | 7.11 | 11.45 | 7.78 | 0.596 |
| Example 5 | 4.79 | 7.36 | 11.21 | 7.78 | 0.406 |
| Example 6 | 3.44 | 5.62 | 9.46 | 6.00 | 0.456 |
| Example 7 | 3.29 | 5.63 | 8.62 | 6.00 | 0.481 |
| Comparative | 3.65 | 6.23 | 10.50 | 6.54 | 0.464 |
| Example 1 | | | | | |
| Comparative | 6.13 | 9.69 | 14.99 | 11.00 | 0.503 |
| Example 2 | | | | | |
| Comparative | 2.82 | 4.57 | 7.56 | 4.62 | 0.395 |
| Example 3 | | | | | |
| Comparative | 2.34 | 3.64 | 5.63 | 3.89 | 0.426 |
| Example 4 | | | | | |

As illustrated in FIGS. 2 to 12, it may be confirmed that the positive electrode active materials prepared in Examples 1 to 7 and Comparative Examples 1 to 4 were all prepared as positive electrode active materials in the form of a single particle which were defined in the present disclosure.

Also, as illustrated in Table 1, it may be confirmed that the positive electrode active materials prepared in Examples 1 to 7 had a D₅₀ of 5 μm or more and a negative skewness calculated by Equation 1 of 0.4 or more, and it may be confirmed that the positive electrode active materials prepared in Comparative Examples 3 and 4 had a D₅₀ of less than 5 μm.

### Experimental Example 2: Rolling Density Measurement

Using an automatic pellet press (Auto Pellet Press, Carver, 3887.4), a zero point of thickness was adjusted for a circular pellet holder having a diameter of 13 mm using a cylindrical mold. Subsequently, 3 g of each of the positive electrode active materials prepared in Examples 1 to 7 and Comparative Examples 1 to 4 were put into the circular pellet holder, and a force was applied until it reached 9,000 kgf to measure a thickness of a formed pellet. Subsequently, a pellet volume was calculated using Equation 2 below, rolling density was calculated using Equation 3 below, and the results thereof are presented in Table 2 below.

$$Pellet volume ( {cm}^{3} ) = {Π ( radius of circular pellet holder )}^{2} \times pellet thickness \qquad [ Equation 2 ]$$

$$Rolling density ( g / {cm}^{3} ) = positive electrode active material weight ( g ) / pellet volume ( {cm}^{3} ) \qquad [ Equation 3 ]$$

TABLE 2

| Category | Rolling density (g/cm³) |
|---|---|
| Example 1 | 3.72 |
| Example 2 | 3.59 |
| Example 3 | 3.61 |
| Example 4 | 3.67 |
| Example 5 | 3.62 |
| Example 6 | 3.56 |
| Example 7 | 3.65 |
| Comparative Example 1 | 3.53 |
| Comparative Example 2 | 3.53 |
| Comparative Example 3 | 3.51 |
| Comparative Example 4 | 3.54 |

As illustrated in Table 2, it may be confirmed that the positive electrode active materials prepared in Examples 1 to 7 had a D₅₀ of 5 μm or more while being in the form of a single particle through adjustment of the primary sintering temperature and the secondary sintering temperature, had an appropriately adjusted amount of the fine powder according to the negative skewness value, and had a rolling density calculated by Equation 3 of 3.56 g/cm³ or more. From these results, in a case in which the positive electrode active material according to the present disclosure is used, it is expected that rolling density during preparation of a positive electrode may be improved to increase energy density of a lithium secondary battery and, accordingly, capacity characteristics may be improved.

In contrast, the secondary sintering temperature was higher than the primary sintering temperature with respect to the positive electrode active material prepared in Comparative Example 1, and the secondary sintering temperature was lower than the primary sintering temperature with respect to the positive electrode active material prepared in Comparative Example 2, but, since a difference between these temperatures was excessively large, rolling density was shown to be 3.53 g/cm³ even though D₅₀ was 5 μm or more while being in the form of a single particle and the amount of the fine powder according to the negative skewness value was adjusted to an appropriate level, and thus, it may be confirmed that it not only did not meet the minimum standard to achieve the effect according to the present disclosure, but there was also a difference of at least 0.06 g/cm³ and up to 0.19 g/cm³ in comparison to Examples 1 and 2 using the positive electrode active material precursor and lithium raw material of the same composition.

Also, since the primary sintering temperature and the secondary sintering temperature were the same with respect to the positive electrode active material prepared in Comparative Example 3, D₅₀ was less than 5 μm as shown in Table 1, and, accordingly, it may be confirmed that rolling density was also low, particularly, a difference in rolling density relative to Example 6 using the positive electrode active material precursor and lithium raw material of the same composition was 0.05 g/cm³.

Furthermore, since the secondary sintering temperature was lower than the primary sintering temperature with respect to the positive electrode active material prepared in Comparative Example 4, but the sintering temperature suitable for the transition metal hydroxide, as the positive electrode active material precursor, was not sufficiently secured, D₅₀ was less than 5 μm as shown in Table 1, and, accordingly, it may be confirmed that rolling density was also low, particularly, a difference in rolling density relative to Example 7 using the positive electrode active material precursor and lithium raw material of the same composition was 0.11 g/cm³.

1. A positive electrode active material, comprising:
a lithium transition metal composite oxide in a form of a single particle containing nickel, cobalt, and manganese,
wherein the lithium transition metal composite oxide contains 60 mol % or more of the nickel among total transition metals,
has a D₅₀ of 5 μm or more, and
has a rolling density calculated by Equation 3 of 3.56 g/cm³ or more when a pellet is formed by applying a force until the force reaches 9,000 kgf using an automatic pellet press
$$Rolling density ( g / {cm}^{3} ) = positive electrode active material weight ( g ) / pellet volume ( {cm}^{3} ) . \qquad [ Equation 3 ]$$

2. The positive electrode active material of claim 1, wherein the lithium transition metal composite oxide in the form of the single particle is a single particle or a secondary particle containing 10 or less primary particles.

3. The positive electrode active material of claim 1, wherein the lithium transition metal composite oxide has an average composition represented by Formula 1: 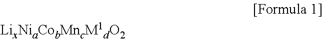
wherein,
M¹ is at least one of aluminum (Al), zirconium (Zr), boron (B), tungsten (W), molybdenum (Mo), chromium (Cr), niobium (Nb), magnesium (Mg), hafnium (Hf), tantalum (Ta), lanthanum (La), titanium (Ti), strontium (Sr), barium (Ba), cerium (Ce), fluorine (F), phosphorus (P), sulfur(S), or yttrium (Y), and
$$0.9 \leq x \leq 1.3 , 0.6 \leq a < 1.0 , 0 < b < 0.4 , 0 < c < 0.4 , 0 \leq d \leq 0.2 , and a + b + c + d = 1 .$$

4. The positive electrode active material of claim 3, wherein x is in a range of from 0.9 to 1.1.

5. The positive electrode active material of claim 1, wherein the D₅₀ is in a range of from 5 μm to 9 μm.

6. The positive electrode active material of claim 1, wherein the rolling density is in a range of from 3.56 g/cm³ to 3.80 g/cm³.

7. The positive electrode active material of claim 1, wherein a mode in a cumulative distribution of volume according to a particle diameter is greater than the D₅₀.

8. The positive electrode active material of claim 7, wherein the positive electrode active material has a negative skewness value calculated by Equation 1 of greater than 0:
$$Negative skewness = ( Mode - {D}_{10} ) / {D}_{50} . \qquad [ Equation 1 ]$$

9. The positive electrode active material of claim 8, wherein the negative skewness value is in a range of from 0.40 to 0.75.

10. A positive electrode comprising the positive electrode active material of claim 1.

11. A lithium secondary battery comprising the positive electrode of claim 10; a negative electrode; a separator disposed between the positive electrode and the negative electrode, and an electrolyte.
